(19) United States
(12) Patent Application Publication
(10) Pub. No.: US 2025/0335494 A1
(43) Pub. Date: Oct. 30, 2025

(54) INFORMATION PROCESSING

(71) Applicant: Tencent Technology (Shenzhen) Company Limited, Shenzhen (CN)

(72) Inventors: Chuangmu YAO, Shenzhen (CN); Yuwei HAN, Shenzhen (CN)

(73) Assignee: Tencent Technology (Shenzhen) Company Limited, Shenzhen, GD (CN)

(21) Appl. No.: 19/262,069

(22) Filed: Jul. 7, 2025

Related U.S. Application Data
(63) Continuation of application No. PCT/CN2023/132699, filed on Nov. 20, 2023.

(30) Foreign Application Priority Data
May 22, 2023 (CN) 202310585405.5

(51) Int. Cl. G06F 16/432; G06F 3/0483; G06F 16/334; G06F 16/438; G06F 40/30

(52) U.S. Cl. CPC G06F 16/432; G06F 3/0483; G06F 16/334; G06F 16/438; G06F 40/30

(57) ABSTRACT

To-be-queried information is received by a server device. The to-be-queried information is transmitted from a terminal device. A multimodal information search is performed by the server device based on the to-be-queried information to obtain multimodal search results. A content digest extraction of a target text in the multimodal search results is performed to obtain one or more content digest fragments. Based on the one or more content digest fragments, a text query result is generated. When a first preset number of search results in the multimodal search results lack a rich media query result, key information extraction on the text query result is performed to obtain key description information. A supplemental rich media query result is acquired according to the key description information. The text query result and the supplemental rich media query result are fused into a target query result that is transmitted to the terminal device.

### RELATED APPLICATIONS

The present application is a continuation of International Application No. PCT/CN2023/132699, filed on Nov. 20, 2023, which claims priority to Chinese Patent Application No. 202310585405.5, filed on May 22, 2023. The entire disclosures of the prior applications are hereby incorporated by reference.

### FIELD OF THE TECHNOLOGY

This disclosure relates to the technical field of Internet, including information processing.

### BACKGROUND OF THE DISCLOSURE

In a scene of customer service dialogs, to resolve labor costs of a large number of customer services, artificial intelligence (AI) may be adopted to conduct dialogs as an alternative to human customer services.

Currently, in a dialog manner of the AI customer service, a user raises a question, and the AI customer service performs text feature extraction based on the question of the user, searches, based on the extracted text feature, a question-answer library for an answer closest to the question raised by the user, and pushes the answer to the user. The dialog manner is limited to texts only. Thus, the dialog manner is relatively simple, thereby reducing the effectiveness and accuracy of communication.

### SUMMARY

Embodiments of this disclosure provide an information processing method and apparatus, a computer device, a computer-readable storage medium, and a computer program product, which may improve the accuracy and diversity of information processing.

To resolve the foregoing technical problem, the embodiments of this disclosure provide the following technical solutions.

Some aspects of the disclosure provide an information processing method. In some examples, to-be-queried information is received by a server device. The to-be-queried information is transmitted from a terminal device. A multimodal information search is performed by the server device based on the to-be-queried information to obtain multimodal search results. A content digest extraction of a target text in the multimodal search results is performed to obtain one or more content digest fragments. A relevance between the target text and the to-be-queried information is greater than a preset relevance threshold. Based on the one or more content digest fragments, a text query result corresponding to the to-be-queried information is generated. When a first preset number of search results in the multimodal search results lack a rich media query result, key information extraction on the text query result is performed to obtain key description information corresponding to the text query result. A supplemental rich media query result is acquired according to the key description information. The supplemental rich media query result includes one or more rich media items. The text query result and the supplemental rich media query result are fused to obtain a target query result. The target query result is transmitted to the terminal device.

Some aspects of the disclosure provide an information processing method to be executed by a terminal device. In some examples, to-be-queried information is received via an interactive interface of the terminal device. The to-be-queried information is transmitted to a server device. A target query result that is generated by the server device based on the to-be-queried information is received. The target query result includes a text query result and a rich media query result that are fused together. The text query result is generated based on one or more content digest fragments that are extracted by performing a content digest extraction of a target text in multimodal search results of the to-be-queried information. A relevance between the target text and the to-be-queried information is greater than a preset relevance threshold. The rich media query result includes one of a first rich media query result obtained based on a first preset number of search results in the multimodal search results, or a supplemental rich media query result acquired based on key description information that is obtained by performing key information extraction on the text query result. The target query result that includes the text query result and the rich media query result is displayed in the interactive interface.

Some aspects of the disclosure provide an information processing apparatus that includes processing circuitry configured to perform one or more of the information processing methods.

Some aspects of the disclosure also provide a non-transitory computer-readable storage medium storing instructions which when executed by at least one processor cause the at least one processor to perform one or more of the information processing methods.

The embodiments of this disclosure provide an information processing method, applied to a server (also referred to as server device in some examples), and including the following operations: receiving to-be-queried information transmitted by a terminal, and performing a multimodal information search based on the to-be-queried information to obtain multimodal search results, the query information being inputted in an interactive interface of the terminal; performing content digest extraction on a target text in the multimodal search results to obtain content digest fragments, relevance between the target text and the to-be-queried information being greater than a preset relevance threshold; generating, based on the content digest fragments, a text query result corresponding to the to-be-queried information; performing, if a first preset number of search results in the multimodal search results do not contain a first rich media query result, key information extraction on the text query result to obtain key description information corresponding to the text query result; acquiring a second rich media query result (also referred to as supplemental rich media query result) corresponding to the key description information; and fusing the text query result and the second rich media query result to obtain a target query result, and transmitting the target query result to the terminal.

The embodiments of this disclosure provide an information processing method, applied to a terminal, and including the following operations: displaying an interactive interface, and receiving inputted to-be-queried information in the interactive interface; transmitting the to-be-queried information to a server, and receiving a target query result returned by the server based on the to-be-queried information, the target query result including a text query result and a rich media query result; the text query result being generated based on content digest fragments obtained by performing content digest extraction on a target text; the target text being a text that is in multimodal search results obtained by performing a multimodal information search for the to-be-queried information and has relevance to the to-be-queried information being greater than a preset relevance threshold; the rich media query result being a first rich media query result obtained based on a first preset number of search results in the multimodal search results, or a second rich media query result acquired based on key description information; the key description information being obtained by performing key information extraction on the text query result; and displaying, in the interactive interface, the text query result and the rich media query result.

The embodiments of this disclosure provide an information processing apparatus, including: a search unit configured to receive to-be-queried information transmitted by a terminal (also referred to as a terminal device in some examples), and perform a multimodal information search based on the to-be-queried information to obtain multimodal search results, the query information being inputted in an interactive interface of the terminal; a first extraction unit configured to perform content digest extraction on a target text in the multimodal search results to obtain content digest fragments, relevance between the target text and the to-be-queried information being greater than a preset relevance threshold; a generation unit configured to generate, based on the content digest fragments, a text query result corresponding to the to-be-queried information; a second extraction unit configured to perform, if a first preset number of search results in the multimodal search results do not contain a first rich media query result, key information extraction on the text query result to obtain key description information corresponding to the text query result; an acquisition unit configured to acquire a second rich media query result corresponding to the key description information; and a fusion unit configured to fuse the text query result and the second rich media query result to obtain a target query result, and transmit the target query result to the terminal.

The embodiments of this disclosure provide an information processing apparatus, including: a first display unit configured to display an interactive interface, and receive inputted to-be-queried information in the interactive interface; a receiving unit configured to transmit the to-be-queried information to a server, and receive a target query result returned by the server based on the to-be-queried information, the target query result including a text query result and a rich media query result; the text query result being generated based on content digest fragments obtained by performing content digest extraction on a target text; the target text being a text that is in multimodal search results obtained by performing a multimodal information search for the to-be-queried information and has relevance to the to-be-queried information being greater than a preset relevance threshold; the rich media query result being a first rich media query result obtained based on a first preset number of search results in the multimodal search results, or a second rich media query result acquired based on key description information; the key description information being obtained by performing key information extraction on the text query result; and a second display unit configured to display, in the interactive interface, the text query result and the rich media query result.

The embodiments of this disclosure provide a computer device, including a processor (an example of processing circuitry) and a memory, the memory having a computer program stored therein, and when invoking the computer program in the memory, the processor performing any information processing method provided in the embodiments of this disclosure.

The embodiments of this disclosure provide a computer-readable storage medium (e.g., non-transitory computer-readable storage medium), configured to store a computer program, the computer program being loaded by a processor to perform any information processing method provided in the embodiments of this disclosure.

The embodiments of this disclosure provide a computer program product, including a computer program, the computer program being loaded by a processor to perform any information processing method provided in the embodiments of this disclosure.

According to the embodiments of this disclosure, the multimodal information search may be performed based on the to-be-queried information to obtain the multimodal search results. Content digest extraction is performed according to the target text in the multimodal search results to obtain the content digest fragments, and the relevance between the target text and the to-be-queried information is greater than the preset relevance threshold. The text query result corresponding to the to-be-queried information is generated based on the content digest fragments. In addition, when the first preset number of search results in the multimodal search results do not contain the first rich media query result, key information extraction may be performed on the text query result to obtain the key description information, and the second rich media query result is acquired based on the key description information. The text query result and the second rich media query result are fused to accurately obtain diversified target query results, thereby improving the accuracy and diversity of information processing.

### BRIEF DESCRIPTION OF THE DRAWINGS

FIG. 1 is a schematic diagram of an application scene of an information processing method according to an embodiment of this disclosure.

FIG. 2 is a schematic flowchart of an information processing method according to an embodiment of this disclosure.

FIG. 3 is a schematic diagram of an interactive interface according to an embodiment of this disclosure;

FIG. 4 is another schematic flowchart of an information processing method according to an embodiment of this disclosure.

FIG. 5 is a schematic diagram of displaying query results in partitions in an interactive interface according to an embodiment of this disclosure.

FIG. 6 is a schematic diagram of displaying an original text according to an embodiment of this disclosure.

FIG. 7 is another schematic diagram of displaying an original text according to an embodiment of this disclosure.

FIG. 8 is a schematic diagram of displaying rich media according to an embodiment of this disclosure.

FIG. 9 is a schematic diagram of page turning display of rich media according to an embodiment of this disclosure.

FIG. 10 is a schematic flowchart of interaction between a terminal and a server according to an embodiment of this disclosure.

FIG. 11 is another schematic flowchart of an information processing method according to an embodiment of this disclosure.

FIG. 12 is a schematic diagram of an information processing apparatus according to an embodiment of this disclosure.

FIG. 13 is another schematic diagram of an information processing apparatus according to an embodiment of this disclosure.

FIG. 14 is a schematic structural diagram of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

The embodiments of this disclosure provide an information processing method and apparatus, a computer device, and a storage medium.

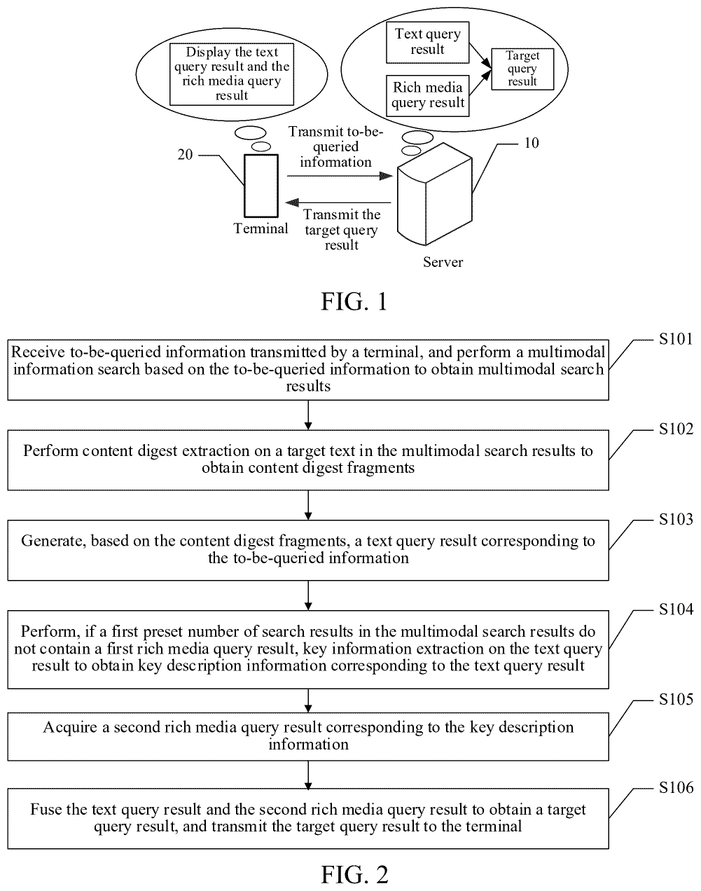

FIG. 1 is a schematic diagram of an application scene of an information processing method according to an embodiment of this disclosure. The information processing method may be applied to an information processing system, and the information processing system may include a server 10, a terminal 20, and the like. The server 10 may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and AI platform. This is not limited thereto. The terminal 20 may be a mobile phone, a computer, a wearable device, or the like. The server 10 and the terminal 20 may be directly or indirectly connected through wired or wireless communication. This is not limited in this disclosure.

The terminal 20 may display an interactive interface, receive, in the interactive interface, to-be-queried information (for example, a question) inputted by a user, and transmit the to-be-queried information to the server 10. The server 10 may perform a multimodal information search based on received to-be-queried information to obtain multimodal search results. The multimodal search results may include search results, such as texts, images, videos, and expressions, sorted in descending order of relevance to the to-be-queried information. Content digest extraction may be performed on a text (for example, an article ranked in a third order) that is in the multimodal search results and has relevance to the to-be-queried information being greater than a preset relevance threshold to obtain content digest fragments. A text query result (for example, a text answer) corresponding to the to-be-queried information is generated based on the content digest fragments. If a first preset number of search results in the multimodal search results do not contain a first rich media query result, key information extraction is performed on the text query result to obtain key description information corresponding to the text query result. A second rich media query result corresponding to the key description information is acquired, the text query result and the second rich media query result are fused to obtain a target query result, and the target query result is transmitted to the terminal. If the first preset number of search results in the multimodal search results contain the first rich media query results, the text query result and the first rich media query results may be directly fused to obtain a target query result. In this case, the target query result may be transmitted to the terminal 20. After receiving the target query result returned by the server based on the to-be-queried information, the terminal 20 may display, in the interactive interface, the target query result containing the text query result, the rich media query result, and the like. The accurately acquired text query result and rich media query result are fused to obtain diversified target query results, thereby improving the accuracy and diversity of information processing.

The schematic diagram of the application scene of the information processing method shown in FIG. 1 is merely an example. The application and scene of the information processing method described in this embodiment of this disclosure are intended to describe the technical solutions in the embodiments of this disclosure and do not constitute a limitation to the technical solutions provided in the embodiments of this disclosure. It is noted that with the evolution of the application of the information processing method and the emergence of a new business scene, the technical solutions provided in the embodiments of this disclosure are further applicable to similar technical problems.

Detailed descriptions are separately provided below. A description order of the following embodiments is not intended to limit the order of the embodiments.

In this embodiment, the information processing method may be applied to a computer device such as a server. An information processing apparatus is integrated in the server. Descriptions are provided below from the perspective of the server.

FIG. 2 is a schematic flowchart of an information processing method according to an embodiment of this disclosure. The information processing method may include the following operations.

S101: Receive to-be-queried information transmitted by a terminal, and perform a multimodal information search based on the to-be-queried information to obtain multimodal search results.

The to-be-queried information may be inputted in an interactive interface of the terminal. The interactive interface may be an interface that is displayed on the terminal and configured for interacting with a user, for example, a search assistant dialog interface or an instant messaging dialog interface. The to-be-queried information may be a question in a text form, or may be a question in an image form, a voice form, or another form. When the terminal receives inputted to-be-queried information in the displayed interactive interface, the server may receive the to-be-queried information that is transmitted by the terminal and inputted in the interactive interface. For example, the server may receive to-be-queried information “Is there a new character in a theme park?” transmitted by the terminal. For another example, the server may receive to-be-queried information “Introduce the Monstera deliciosa” transmitted by the terminal. For another example, the server may receive to-be-queried information “How to raise Monstera deliciosa” transmitted by the terminal.

After obtaining the to-be-queried information, the server may invoke a search engine service to perform a multimodal information search based on the to-be-queried information to obtain multimodal search results. The multimodal search results may include at least one search result of a text (for example, an article), an image, an expression, music, a video, and the like. The multimodal search results may be search results sorted in descending order of relevance to the to-be-queried information.

When the to-be-queried information is in the text form, to improve the search accuracy, the server may obtain standardized to-be-queried information (query) after performing processing such as voice analysis or keyword extraction on the to-be-queried information through a chat generative pre-trained transformer (ChatGPT) model, a natural language processing (NLP) model, or the like, and then invoke a search engine service to perform multimodal information search based on the standardized to-be-queried information to obtain multimodal search results.

For example, the to-be-queried information may be extracted based on a question template (query prompt) through ChatGPT. The question template (query prompt) may be as follows.

You are a query understanding assistant, and list queries suitable for retrieval according to my task. Each query is outputted in a pair of { }, and the task is: the most important requirement when the user searches for “% s” is recognized, and only one retrieval query that may satisfy the requirement is outputted,

where “% s” represents receiving the to-be-queried information that is transmitted by the terminal and inputted in the interactive interface.

A plurality of queries may further be obtained by extracting the to-be-queried information based on the question template (query prompt) through the ChatGPT. In this case, the queries may be searched and then summarized to obtain multimodal search results having high relevance.

When the to-be-queried information is in the image form, to improve the search accuracy, the server may recognize the to-be-queried information through an image recognition model to extract image feature information such as words and objects included in the image, and then invoke the search engine service to perform a multimodal information search based on the image feature information to obtain multimodal search results.

In this embodiment, AI may be adopted to process information, which may improve the accuracy of information processing. AI is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology of computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. An AI software technology mainly includes a machine learning (ML) technology. Deep learning (DL) is a new research direction in ML and is introduced to ML to make ML closer to an initial target, i.e., AI. Currently, DL is mainly applied to fields such as machine vision, voice processing technologies, and NLP.

S102: Perform content digest extraction on a target text in the multimodal search results to obtain content digest fragments.

The multimodal search results may include search results sorted in descending order of relevance to the to-be-queried information. After obtaining the multimodal search results, the server may screen, from the multimodal search results, a target text whose relevance to the to-be-queried information is greater than a preset relevance threshold, that is, the relevance between the target text and the to-be-queried information is greater than the preset relevance threshold. The preset relevance threshold may be flexibly set according to an actual requirement and is not limited herein. That is, preset texts having high relevance to the to-be-queried information may be screened from the multimodal search results, for example, one or more texts that rank the first three may be referred to as header search results. Then, content digest extraction is performed on the screened texts to obtain one or more content digest fragments. The content digest fragments may accurately summarize content corresponding to the text, and have coherent semantics and clear formats. For one text, one or more content digest fragments may be extracted. A content digest extraction manner is not limited herein. For example, content digest extraction may be performed, through ChatGPT or another language model, on the target text that is in the multimodal search results and has relevance to the to-be-queried information being greater than the preset relevance threshold to obtain content digest fragments.

To improve the reliability of acquiring the content digest fragments, the server may acquire a title of a target text that is in the multimodal search results and has relevance to the to-be-queried information being greater than the preset relevance threshold, perform relevance calculation on the title and the to-be-queried information, reserve a search result having relevance maximized greater than the preset threshold, and perform full-text content analysis and extraction on the reserved text to obtain one or more content digest fragments. The preset threshold is not limited herein. In addition, according to an actual requirement, a length window may be set as required for the content digest fragment in an original text to perform forward and backward text expansion to obtain an expanded content digest fragment, so as to generate, based on the expanded content digest fragment, a text query result corresponding to the to-be-queried information.

S103: Generate, based on the content digest fragments, a text query result corresponding to the to-be-queried information.

The text query result may include the content digest fragments, text reference jump links corresponding to the content digest fragments, and the like. The text reference jump link may be a reference mark to which a hyper text markup language (HTML) label is added. The original text corresponding to a source text link may be jumped to through the text reference jump link. The source text link may be a uniform resource locator (URL) of the text. After obtaining the content digest fragments, the server may generate, through ChatGPT, the text query result corresponding to the to-be-queried information based on information such as the content digest fragments and the text reference jump links. For example, content digest fragments corresponding to a plurality of texts may be reserved in descending order of relevance. The plurality of content digest fragments are sequentially numbered. For example, a content digest fragment of a first text 1 is labeled as 1, a content digest fragment of a second text 2 is labeled as 2, and so on. The content digest fragments are concatenated together, and numbers corresponding to the content digest fragments are added to the concatenated text. For example, a content digest fragment 1 (whose content is xxxxxx) and a content digest fragment 2 (whose content is yyyyyy) are extracted from the text 1, and a content digest fragment 3 (whose content is zzzzzz) is extracted from the text 2. Thus, the concatenated text is xxxxxx[1]yyyyyy[1]zzzzzz[2], and a corresponding <a href=“https://xxx”>html label is added to each of pure texts of [1] and [2] to form a text reference jump link.

In an implementation, there are a plurality of content digest fragments, and the generating, based on the content digest fragments, a text query result corresponding to the to-be-queried information includes: using the plurality of content digest fragments as inputs of the generation model, concatenating, through the generation model, the plurality of content digest fragment according to a preset text generation template, and adding text reference jump links corresponding to the content digest fragments to output the text query result corresponding to the to-be-queried information.

The generation model may be ChatGPT or another language model. This is not limited herein. To improve the richness of the text query result, the server may generate the text query result based on a plurality of content digest fragments and text reference jump links. The plurality of content digest fragments may be obtained by performing content digest extraction on the same text, or obtained by performing content digest extraction on a plurality of texts. For example, the plurality of content digest fragments may be used as inputs of ChatGPT. The plurality of content digest fragments are concatenated through ChatGPT according to the preset text generation template to obtain a concatenated text. The text reference jump links corresponding to the content digest fragments are added at a position corresponding to the content digest fragments in the concatenated text so that the text query result corresponding to the to-be-queried information may be outputted.

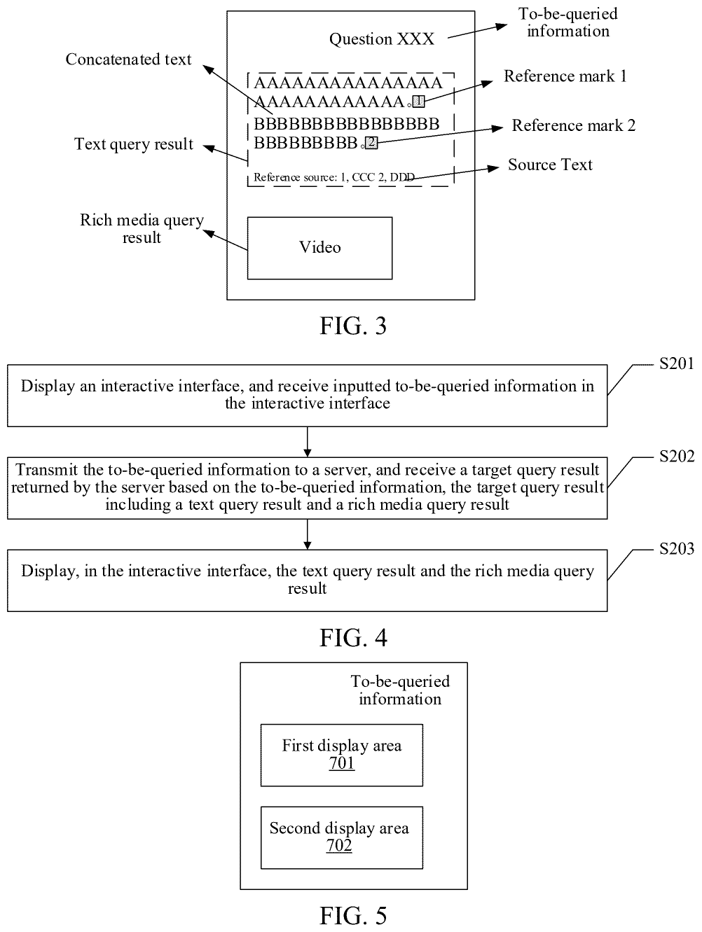

For example, as shown in FIG. 3, a reference mark 1 (i.e., a text reference jump link) corresponding to a content digest fragment A may be added at a tail position corresponding to the content digest fragment A in the concatenated text to indicate that the content digest fragment A derives from a source text 1. A reference mark 2 corresponding to a content digest fragment B is added at a tail position corresponding to the content digest fragment B in the concatenated text to indicate that the content digest fragment B derives from a source text 2. In addition to including the concatenated text and the text reference jump links, the text query result may further include reference sources corresponding to the content digest fragments. A corresponding html<a> label may be added to the reference source to form a hyperlink text, i.e., a source text link of the source text corresponding to the content digest fragment.

The preset text generation template may be a prompt format set for ChatGPT or another language model. For example, the preset text generation template may be as follows.

According to the question “% s” and content extraction information (i.e., the plurality of content digest fragments) of the text, an answer of no more than “% x” words is generated. Based on a goal of answering the question “% s” as perfectly as possible, irrelevant information is discarded so that the semantics is coherent, and the format is clear. A reference form ¥ “[digit] Y” is adopted to mark which source text and paragraph being the source of each sentence in your reply. Only reference is needed, no comments. A paragraph with poor relevance is not cited.

“% s” represents the to-be-queried information, and “% x” may be 400 or another number. For example, an answer of no more than 400 words may be generated, and [digit] may include [1], [2], and [3], representing an order of the source text.

In an implementation, the concatenating, through the generation model, the plurality of content digest fragments according to a preset text generation template, and adding text reference jump links corresponding to the content digest fragments to output the text query result corresponding to the to-be-queried information may include: concatenating, through the generation model, the plurality of content digest fragments according to the preset text generation template to output a concatenated text; performing semantic matching between the concatenated text and an original text corresponding to the content digest fragments; and adding, if the concatenated text and the original text corresponding to the content digest fragments satisfy a matching condition, the text reference jump links corresponding to the content digest fragments to the concatenated text to obtain the text query result.

For example, the server may acquire the original text (i.e., the source text) corresponding to the content digest fragments, concatenate, through ChatGPT, the plurality of content digest fragments according to the preset text generation template to output a concatenated text, and then perform semantic matching between the concatenated text and the original text corresponding to the content digest fragments. If the concatenated text and the original text corresponding to the content digest fragments satisfy the matching condition, the text reference jump links corresponding to the content digest fragments are added to the concatenated text to obtain the text query result. If the concatenated text and the original text corresponding to the content digest fragments do not satisfy the matching condition, the text reference jump links corresponding to the content digest fragments are not added, thereby improving the accuracy of acquiring the text query result.

In some embodiments, a semantic matching degree between the concatenated text and the original text corresponding to the content digest fragments may be determined using a preset semantic matching algorithm or a trained semantic matching model. If the semantic matching degree is greater than a preset matching degree threshold, it is determined that the concatenated text and the original text corresponding to the content digest fragments satisfy the matching condition. If the semantic matching degree is less than or equal to the matching degree threshold, it is determined that the concatenated text and the original text corresponding to the content digest fragments do not satisfy the matching condition.

After generating the text query result containing the concatenated text and the reference labels, the server may perform semantic matching between the concatenated text and the original text corresponding to the content digest fragments. If the concatenated text and the original text corresponding to the content digest fragments satisfy the matching condition, the reference labels corresponding to the content digest fragments are kept to be added to the concatenated text, and a reference source link is added to each of the pure text of the reference label and a corresponding <a href=“https://xxx”>html label to generate the text reference jump links corresponding to the content digest fragments. If the concatenated text and the original text corresponding to the content digest fragments do not satisfy the matching condition, the added reference labels corresponding to the content digest fragments are deleted from the concatenated text.

In an implementation, after the performing a multimodal information search based on the to-be-queried information to obtain multimodal search results, the information processing method may further include: fusing, if the first preset number of search results in the multimodal search results contain first rich media query results, the text query result and the first rich media query results to obtain a target query result; and transmitting the target query result to the terminal. The multimodal search results include a plurality of search results sorted in descending order of relevance to the to-be-queried information. The first preset number of search results in the multimodal search results are a preset number of search results starting from the first in the multimodal search results. Assuming that the preset number is 5, the first preset number of search results in the multimodal search results are the first 5 search results in the multimodal search results.

After the multimodal search results are obtained, since the multimodal search results may be search results sorted in descending order of relevance to the to-be-queried information, the server may determine whether the first preset number of search results that are in the multimodal search results and have high relevance to the to-be-queried information contain the first rich media query results. The first preset number of search results may be flexibly set according to an actual requirement and is not limited herein. For example, the server may determine whether the first three search results in the multimodal search results contain the first rich media query results such as videos, expressions, images, or audio. If the first preset number of search results in the multimodal search results contain the first rich media query results, the text query result and the first rich media query results may be directly fused to obtain the target query result. A fusion manner is not limited herein. For example, the text query result and the first rich media query result may be concatenated head-to-tail to obtain the target query result, or the first rich media query result may be inserted into an appropriate position of the text query result to obtain the target query result. After obtaining the target query result, the server may transmit the target query result containing the text query result and the first rich media query results to the terminal so that the terminal displays, in the interactive interface, the text query result and the first rich media query results.

In an implementation, the fusing, if the first preset number of search results in the multimodal search results contain first rich media query results, the text query result and the first rich media query results to obtain a target query result may include: determining, if the first preset number of search results in the multimodal search results contain the first rich media query results, whether rich media types of the first rich media query results contained in the first preset number of search results are the same; fusing, if the rich media types are the same, a first rich media query result ranking first in the first preset number of search results with the text query result to obtain the target query result; and fusing, if the rich media types are different, first rich media query results of various types ranking first among the first preset number of search results with the text query result to obtain the target query result.

There may be multiple types of rich media, such as a video, an expression, an image, or audio. To improve the accuracy and efficiency of acquiring a query result, the rich media type may be determined first, and then a matched rich media query result is accurately acquired based on the rich media type. In some embodiments, when the first preset number of search results in the multimodal search results contain the first rich media query results, the server may determine whether the rich media types of the first rich media query results contained in the first preset number of search results are the same, for example, may determine whether the rich media types of rich media contained in the first three search results in the multimodal search results are the same. If the rich media types are the same, the first rich media query result ranking first in the first preset number of search results is fused with the text query result to obtain the target query result. If the rich media types are different, the first rich media query results of various types ranking first among the first preset number of search results are fused with the text query result to obtain the target query result. For example, a rich media query result 1 of the rich media type A ranking first and a rich media query result 2 of the rich media type B ranking first may be fused with the text query result to obtain a target query result. For another example, the rich media query result 1 of the rich media type A ranking first may be fused with the text query result to obtain a first query result, and the rich media query result 2 of the rich media type B ranking first may be fused with the text query result to obtain a second query result. The first query result and the second query result are combined to obtain the target query result.

S104: Perform, if a first preset number of search results in the multimodal search results do not contain a first rich media query result, key information extraction on the text query result to obtain key description information corresponding to the text query result.

After the multimodal search results are obtained, since the multimodal search results may be search results sorted in descending order of relevance to the to-be-queried information, it may be determined whether the first preset number of search results that are in the multimodal search results and have high relevance to the to-be-queried information contain the first rich media query results. For example, it may be determined whether the first three search results in the multimodal search results contain the first rich media query results such as videos, expressions, images, or audio. If the first preset number of search results in the multimodal search results do not contain a first rich media query result, key information extraction is performed on the text query result to obtain the key description information corresponding to the text query result.

In an implementation, the performing key information extraction on the text query result to obtain key description information corresponding to the text query result may include: using the text query result as an input of a generation model, and performing, based on integrity of text content, containing specified key information and a word count requirement, key information extraction through the generation model to obtain the key description information corresponding to the text query result.

To improve the accuracy and efficiency of acquiring the key description information, the server may use the text query result as the input of the generation model and output the key description information through the generation model. The generation model may be the ChatGPT model, a language model, or the like. For example, a text in the text query result may be used as an input of ChatGPT, and an information extraction template is invoked through ChatGPT. The information extraction template may be as follows.

You are a query output assistant. Please output strictly according to the following rules.

A query most suitable for retrieval is listed according to the text content, for further acquiring more complete information about the text content from a search engine. An output format is as follows: the query is outputted in a pair of { }, where the query includes key information such as a brand image as much as possible, and the length of the query is less than 10 words as much as possible. The text content is % s,

where “% s” is text in the text query result.

The information extraction template is invoked through ChatGPT, and key information extraction is performed based on integrity of the text content in the information extraction template, containing prompt information such as specified key information and a word count requirement, to obtain the key description information corresponding to the text query result. The key description information may be configured for accurately summarizing the text content in the text query result. The specified key information, the word count requirement, and the like may be flexibly set according to an actual requirement and are not limited herein. For example, the specified key information may include a brand image or a character, and the word count requirement may be no more than 10 words.

For example, the text content is as follows. Yes, a park launched a new cartoon character “Little Panda Meimei” on March 10. She is a fluffy red panda with deep red hands and feet. She has a wide body, short legs, and a large and plump tail on her back. Meimei is a character from an animated movie of a theme park released in March 2022. The movie tells the story of the 13-year-old Asian girl Meimei, who inherited the ability of “turning into a red panda when agitated” from her family, and a series of unpleasant events occurred with her mother in the process of youth growth, and finally reconciled. Thus, the key description information may be extracted as follows: little panda Meimei in a theme park.

After obtaining the key description information, the server may search for a corresponding rich media query result based on the key description information to fully use the search engine service capability and effect, and combine the search and ChatGPT capabilities to jointly improve the query quality.

An order of performing operation S104 and operation S102 may be flexibly set according to an actual requirement and is not limited herein. For example, operation S104 may be first performed and then operation S102 is performed, operation S104 and operation S102 are simultaneously performed, or operation S102 is first performed and then operation S104 is performed.

S105: Acquire a second rich media query result corresponding to the key description information.

For example, the server may perform a multimodal information search based on the key description information to obtain multimodal search results sorted in descending order of relevance to the key description information, and use a rich media query result that is in the multimodal search results and has relevance to the key description information being greater than a target relevance threshold as the second rich media query result corresponding to the key description information. The target relevance threshold may be flexibly set according to an actual requirement and is not limited herein. For another example, the server may generate, through a media generation model, rich media based on the key description information to obtain the second rich media query result. The media generation model is not limited herein. For another example, the server may perform a multimodal information search based on the key description information to obtain multimodal search results sorted in descending order of relevance to the key description information, determine whether a first preset number of search results having high relevance to the key description information in the multimodal search results contain a rich media query result, and if the first preset number of search results contain the rich media query result, use the rich media query result that is in the multimodal search results and has relevance to the key description information being greater than the target relevance threshold as the second rich media query result corresponding to the key description information. If the first preset number of search results do not contain the rich media query result, the text query result may be transmitted to the terminal.

In an implementation, the acquiring a second rich media query result corresponding to the key description information may include: performing, if the key description information is inconsistent with the to-be-queried information, an information search based on the key description information to obtain a search result; and determining the second rich media query result corresponding to the key description information according to rich media that is in the search result and has relevance to the key description information being greater than a target relevance threshold.

For example, the server may first determine whether the key description information is consistent with semantics, words, or contained objects of the to-be-queried information. If the key description information is inconsistent with the semantics, words, or contained objects of the to-be-queried information, the key description information is inconsistent with the to-be-queried information. In this case, an information search may be performed based on the key description information. For example, a search engine is invoked to perform a multimodal information search to obtain search results. The search results may be search results sorted in descending order of relevance to the key description information. If the first preset number of search results contain rich media, a query result corresponding to the to-be-queried information includes the text query result and the rich media query result in an example. In this case, rich media that is in the search results and has relevance to the key description information being greater than the target relevance threshold as well as information such as links related to the rich media may be adopted to generate a second rich media query result corresponding to the key description information so that a rich media query result may be obtained with reference to the search capability, thereby improving the richness of the query result. If the first preset number of search results do not contain rich media, only the text query result may be transmitted to the terminal. If the key description information is consistent with the to-be-queried information, the query result corresponding to the to-be-queried information includes only the text query result in an example. In this case, the text query result may be transmitted to the terminal so that the terminal displays, in the interactive interface, the text query result.

In an embodiment, the determining the second rich media query result corresponding to the key description information according to rich media that is in the search result and has relevance to the key description information being greater than a target relevance threshold may include: acquiring a rich media cover link, a rich media jump link, and rich media click backhaul information of the rich media that is in the search result and has relevance to the key description information being greater than the target relevance threshold; and generating the second rich media query result corresponding to the key description information according to the rich media cover link, the rich media jump link, and the rich media click backhaul information.

The second rich media query result may include the rich media, the rich media cover link, the rich media jump link, the rich media click backhaul information (cookie), and the like. The rich media cover link, the rich media jump link, and the rich media click backhaul information may be configured for subsequent interaction. For example, the rich media jump link may be configured for jumping to a rich media detail page after being triggered. The rich media click backhaul information may be cookie information for requesting a background service when more related rich media continues to be recommended after jumping to the rich media detail page by clicking. The rich media click backhaul information may include a rich media type, a query character string identifier (docid), extracted key description information, and the like. The information may be encoded into a character string in a particular encoding manner. The server acquires the rich media cover link, the rich media jump link, and the rich media click backhaul information of the rich media that is in the search result and has relevance to the key description information being greater than the target relevance threshold, and fuses the rich media cover link, the rich media jump link, and the rich media click backhaul information to obtain the second rich media query result corresponding to the key description information. The server may further use the current rich media query result as a seed to search for similar rich media query results. The structures of the text query result and the rich media query result may be shown in the following table.

| Composition of | Structural element of | |
|---|---|---|
| query result | query result | Effect |
| Text query | Content digest fragment | Text content of displayed |
| result | (concatenated text) | answer |
| | Text reference jump link | Click the reference mark to |
| | (reference mark added | jump to a corresponding |
| | with HTML label) | source text |
| Rich media | Rich media cover link | Rich media card cover image |
| query result | | for displaying |
| | Rich media jump link | Click to jump to a rich media |
| | | detail page |
| | Rich media click | cookie information returned |
| | backhaul information | when swiping down for page |
| | | turning or viewing more |
| | | operations to invoke a |
| | | background service after |
| | | jumping to the rich media |
| | | detail page by clicking |

S106: Fuse the text query result and the second rich media query result to obtain a target query result, and transmit the target query result to the terminal.

A fusion manner is not limited herein. For example, the text query result and the second rich media query result may be concatenated head-to-tail to obtain the target query result, or the second rich media query result may be inserted into an appropriate position of the text query result to obtain the target query result. After obtaining the target query result, the server may transmit the target query result containing the text query result and the second rich media query result to the terminal so that the terminal displays, in the interactive interface, the text query result and the second rich media query result. For example, if information related to rich media such as a video is not mentioned in the to-be-queried information, but it is determined through analysis that the query result containing the text query result and the second rich media query result is preferred, the target query result containing the text query result and the second rich media query result may be acquired and transmitted to the terminal. For example, as shown in FIG. 3, the terminal may display, in the interactive interface, the received text query result and the second rich media query result.

According to this embodiment of this disclosure, the multimodal information search may be performed based on the to-be-queried information to obtain the multimodal search results. Content digest extraction is performed according to the target text that is in the multimodal search results and has relevance to the to-be-queried information being greater than the preset relevance threshold to obtain the content digest fragments. The text query result corresponding to the to-be-queried information is generated based on the content digest fragments. In addition, when the first preset number of search results in the multimodal search results do not contain the first rich media query result, key information extraction may be performed on the text query result to obtain the key description information, and the second rich media query result is acquired based on the key description information. The text query result and the second rich media query result are fused to accurately obtain diversified target query results, thereby improving the accuracy and diversity of information processing.

In this embodiment, the information processing method may be applied to a computer device such as a terminal. An information processing apparatus is integrated in the terminal. Descriptions are provided below from the perspective of the terminal.

FIG. 4 is a schematic flowchart of an information processing method according to an embodiment of this disclosure. The information processing method may include the following operations.

S201: Display an interactive interface, and receive inputted to-be-queried information in the interactive interface.

S202: Transmit the to-be-queried information to a server, and receive a target query result returned by the server based on the to-be-queried information, the target query result including a text query result and a rich media query result; the text query result being generated based on content digest fragments obtained by performing content digest extraction on a target text; the target text being a text that is in multimodal search results obtained by performing a multimodal information search for the to-be-queried information and has relevance to the to-be-queried information being greater than a preset relevance threshold; the rich media query result being a first rich media query result obtained based on a first preset number of search results in the multimodal search results, or a second rich media query result acquired based on key description information; the key description information being obtained by performing key information extraction on the text query result.

S203: Display, in the interactive interface, the text query result and the rich media query result.

In the embodiments of this disclosure, the descriptions of the embodiments have respective focuses. A part that is not described in detail in an embodiment may refer to the above description of the information processing method.

After receiving the target query result returned by the server based on the to-be-queried information, the terminal may display, in the interactive interface, the target query result. For example, if the target query result contains only the text query result, the terminal may display, in the interactive interface, the text query result. If the target query result contains the text query result and the rich media query result, the terminal may display, in the interactive interface, the text query result and the rich media query result. In this case, the terminal may receive a trigger operation for the text query result or the rich media query result, and view, transmit, or play the text query result or the rich media query result. This is not limited herein.

In an implementation, the text query result includes texts and text reference jump links, and the rich media query result includes rich media, a rich media cover link, a rich media jump link, and rich media click backhaul information; and the displaying, in the interactive interface, the text query result and the rich media query result may include: displaying, in a first display area of the interactive interface, the texts and the text reference jump links; and displaying, in a second display area of the interactive interface, a rich media identifier generated by the rich media, the rich media cover link, the rich media jump link, and the rich media click backhaul information.

The text contained in the text query result may be a concatenated text obtained by concatenating based on the content digest fragments. To improve the display effect, the text query result and the rich media query result may be displayed in regions. For example, as shown in FIG. 5, the terminal may display, in a first display area 701 of an interactive interface, a text and a text reference jump link. A corresponding source text (i.e., the original text) may be jumped to through the text reference jump link. The terminal may display, in a second display area 702 of the interactive interface, a rich media identifier. The rich media identifier may include rich media, a rich media cover link, a rich media jump link, rich media click backhaul information, and the like. By performing an operation such as clicking or pressing on the rich media identifier, the rich media jump link may be triggered to jump to a rich media detail page to display the rich media. The type, size, shape, color, and the like of the rich media identifier may be flexibly set according to an actual requirement and are not limited herein.

In an implementation, after the displaying, in the interactive interface, the text query result and the rich media query result, the information processing method further includes: displaying, in response to a trigger operation for the text reference jump link, an original text corresponding to the text reference jump link.

The triggering operation for the text reference jump link may be a clicking operation, a pressing operation, a sliding operation, a voice wakeup operation, a gesture wakeup operation, or the like. This is not limited herein. After displaying the text query result, the terminal may receive a trigger operation for the text reference jump link contained in the text query result inputted by the user, and display, in response to the trigger operation, the original text (i.e., the source text) corresponding to the text reference jump link to facilitate viewing by the user, thereby improving the display convenience and flexibility. To facilitate the user to view the position of the content digest fragment in the original text, the content digest fragment may further be highlighted or displayed in bold in the original text. For example, when a reference mark is set to mark an original text number, a mapping relationship between a content digest fragment corresponding to each number and the source text may be recorded. According to the recorded mapping relationship between the number of the reference mark and the corresponding source text, and with reference to a position of the referenced content digest fragment in the source text, corresponding position marking information may be set on the text reference jump link and is used as an html<a href> label of the reference mark. The position of the corresponding content digest fragment in the original text may be jumped to when the reference mark is triggered, and is highlighted or displayed in bold.

In an implementation, the displaying an original text corresponding to the text reference jump link may include: displaying, in the interactive interface, a dialog box in a pop-up manner, and displaying, in the dialog box, the original text corresponding to the text reference jump link; or switching the interactive interface to a text display interface, and displaying, in the text display interface, the original text corresponding to the text reference jump link.

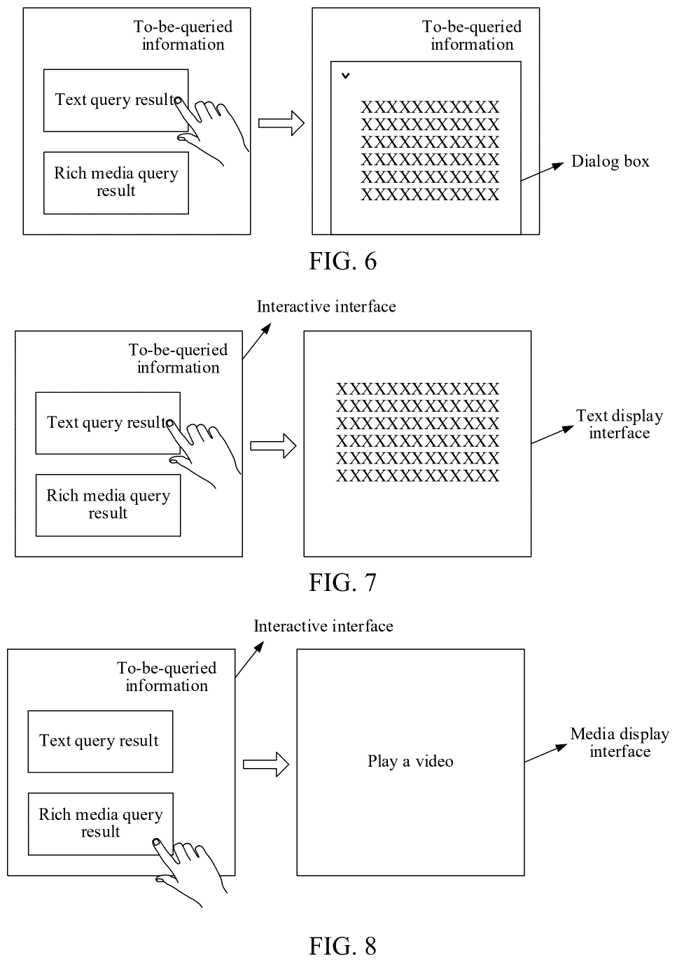

For example, as shown in FIG. 6, the terminal may display, in the interactive interface, a dialog box in a pop-up manner and display, in the dialog box, the original text corresponding to the text reference jump link, thereby improving the text display flexibility. For another example, as shown in FIG. 7, the terminal may switch the interactive interface to a text display interface and display, in the text display interface, the original text corresponding to the text reference jump link, which may facilitate the user to globally view the original text.

In an implementation, after the displaying, in the interactive interface, the text query result and the rich media query result, the information processing method further includes: generating, in response to a trigger operation for the rich media jump link, a media display interface, and displaying, in the media display interface, rich media corresponding to the rich media jump link.

The triggering operation for the rich media jump link may be a clicking operation, a pressing operation, a sliding operation, a voice wakeup operation, a gesture wakeup operation, or the like. This is not limited herein. For example, as shown in FIG. 8, after displaying the rich media query result, the terminal may generate, in response to the trigger operation for the rich media jump link in the rich media query result, the media display interface and display, in the media display interface, the rich media corresponding to the rich media jump link. For example, a video may be played in the media display interface, thereby improving the rich media display flexibility.

When there are a plurality of rich media types in the rich media query result, the plurality of types of rich media may be grouped and displayed. Rich media of the same type is divided into the same group and may be switched to different groups for displaying through a switching button. Alternatively, the plurality of types of rich media may be mixed and displayed, and the like. This is not limited herein.

In an implementation, after the displaying, in the interactive interface, the text query result and the rich media query result, the information processing method further includes: acquiring, in response to a trigger operation for the rich media click backhaul information, a rich media type of the rich media; and acquiring candidate rich media matching the rich media type, and displaying, in the media display interface, the candidate rich media.

The triggering operation for the rich media click backhaul information may be a clicking operation, a pressing operation, a sliding operation, a voice wakeup operation, a gesture wakeup operation, or the like. This is not limited herein. After displaying the rich media query result, the terminal may trigger, in response to the trigger operation for the rich media click backhaul information in the rich media query result, a recommendation process of related rich media, first acquire the rich media type of the rich media, then acquire the candidate rich media matching the rich media type, and display, in the media display interface, the candidate rich media. For example, a rich media detail page containing the rich media may be first displayed in the media display interface by triggering the rich media jump link. The rich media click backhaul information cookie is set in the rich media detail page. The rich media type of the rich media is acquired by triggering the rich media click backhaul information cookie. In addition, a server may be requested, based on the to-be-queried information or the key description information, to search for rich media matching the rich media type to obtain the candidate rich media, or a vertical search system corresponding to the rich media type is invoked to search for the rich media matching the rich media type to obtain the candidate rich media so that the candidate rich media may be displayed in the media display interface.

In an implementation, there are a plurality of pieces of candidate rich media, and the displaying, in the media display interface, the candidate rich media may include: receiving a page turning instruction, and switching, based on the page turning instruction, the candidate rich media currently displayed in the media display interface to another candidate rich media for displaying.

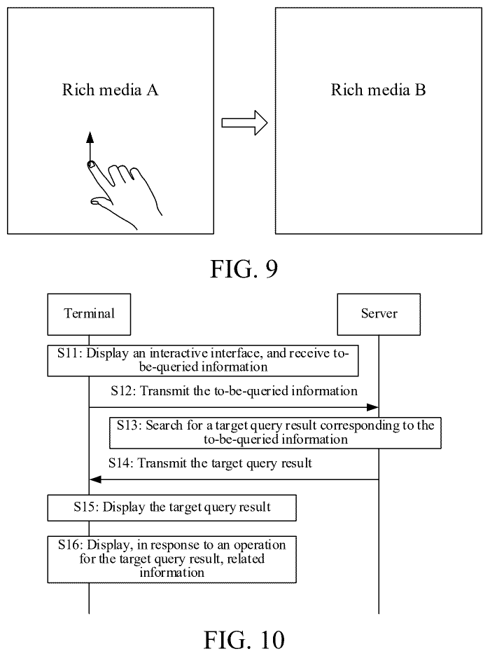

The page turning instruction may be a sliding instruction, a voice switching instruction, a gesture switching instruction, or the like. This is not limited herein. For example, as shown in FIG. 9, when receiving, in the media display interface, a sliding instruction that is inputted by a user to slide up, the terminal may switch the candidate rich media currently displayed in the media display interface to another candidate rich media for displaying, for example, switching from rich media A to rich media B for displaying.

According to this embodiment of this disclosure, based on the target text that is in the multimodal search results obtained by performing a multimodal information search on the to-be-queried information and has relevance to the to-be-queried information being greater than the preset relevance threshold, content digest extraction may be performed to obtain the content digest fragments, thereby generating the text query result. In addition, key information extraction is performed on the text query result to obtain the key description information, and the second rich media query result is acquired based on the key description information. The text query result and the second rich media query result are displayed in the interactive interface, thereby improving the diversity and accuracy of the query result display.

According to the method described in the foregoing embodiment, the following will be described in further detail using examples.

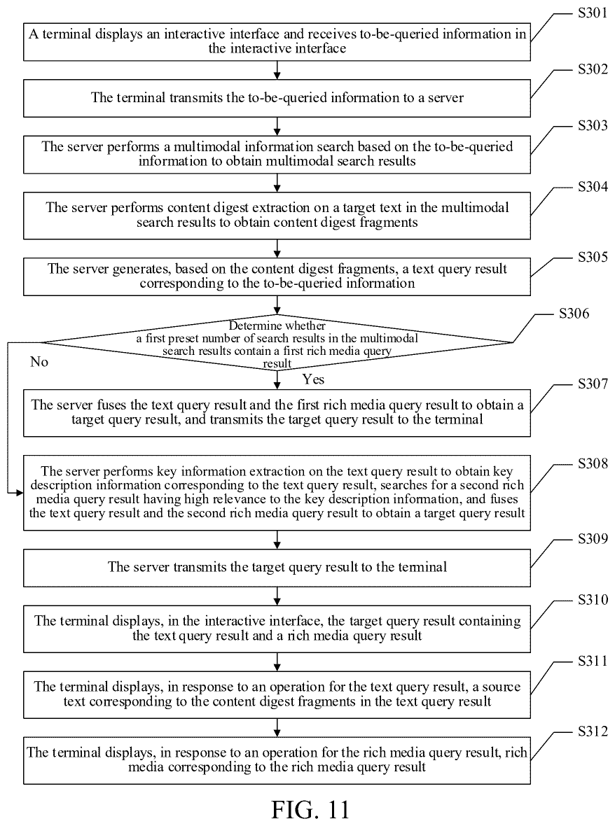

In this embodiment, an example in which the information processing method is applied to an information processing system is used. The information processing system may include a terminal and a server. The terminal and the server may interact with each other. For example, as shown in FIG. 10, the terminal may display an interactive interface, receive to-be-queried information (which may be referred to as a question) in the interactive interface, and transmit the to-be-queried information to the server. The server may search for a target query result (which may be referred to as an answer) corresponding to the to-be-queried information and transmit the target query result to the terminal. The target query result may include a text query result, a rich media query result, and the like. The terminal may display the target query result and further display, in response to an operation for the target query result, related information. For example, the terminal may display a source text or rich media. In some embodiments, FIG. 11 is a schematic flowchart of an information processing method according to an embodiment of this disclosure. The method may include the following operations.

S301: A terminal displays an interactive interface and receives to-be-queried information in the interactive interface.

S302: The terminal transmits the to-be-queried information to a server.

S303: The server performs a multimodal information search based on the to-be-queried information to obtain multimodal search results.

S304: The server performs content digest extraction on a target text in the multimodal search results to obtain content digest fragments.

Relevance between the target text and the to-be-queried information is greater than a preset relevance threshold.

S305: The server generates, based on the content digest fragments, a text query result corresponding to the to-be-queried information.

For example, the server may generate, through ChatGPT, the text query result corresponding to the to-be-queried information based on the content digest fragments.

S306: The server determines whether a first preset number of search results in the multimodal search results contain a first rich media query result. If yes, operation S307 is performed, and if no, operation S308 is performed.

S307: The server fuses the text query result and the first rich media query result to obtain a target query result, and transmits the target query result to the terminal.

S308: The server performs key information extraction on the text query result to obtain key description information corresponding to the text query result, searches for a second rich media query result having high relevance to the key description information, and fuses the text query result and the second rich media query result to obtain a target query result.

S309: The server transmits the target query result to the terminal.

For example, the server may perform key information extraction on the text query result through ChatGPT to obtain the key description information corresponding to the text query result. If a rich media query result having high relevance to the key description information is found, the text query result and the rich media query result may be fused to obtain a target query result, and the target query result is transmitted to the terminal. If the rich media query result having high relevance to the key description information is not found, the text query result may be transmitted to the terminal. High relevance may be that the relevance is greater than a preset threshold. The preset threshold is not limited herein. Alternatively, high relevance may be that multimodal search results that are in the first preset number (for example, the first three) of the multimodal search results obtained by performing the multimodal information search based on the key description information and sorted in descending order of relevance to the key description information, i.e., the first preset number of rich media query results, are rich media query results having high relevance to the key description information.

S310: The terminal displays, in the interactive interface, the target query result containing the text query result and a rich media query result.

S311: The terminal displays, in response to an operation for the text query result, a source text corresponding to the content digest fragments in the text query result.

For example, the terminal may receive a trigger operation for a text reference jump link contained in the text query result inputted by the user, and display, in response to the trigger operation, a source text corresponding to the text reference jump link, i.e., the source text corresponding to the content digest fragments.

S312: The terminal displays, in response to an operation for the rich media query result, rich media corresponding to the rich media query result.

For example, the terminal may jump to, in response to a trigger operation for a rich media jump link in the rich media query result, a media display interface, display, in the media display interface, rich media corresponding to the rich media jump link, and recommend related rich media or display rich media by page turning, or the like.

An order of performing operation S304 and operation S306 may be flexibly set according to an actual requirement and is not limited herein. For example, operation S306 may be first performed and then operation S304 is performed, or operation S304 and operation S306 are simultaneously performed. In addition, an order of performing operation S311 and operation S312 may be flexibly set according to an actual requirement and is not limited herein. For example, operation S312 may be first performed and then operation S311 is performed.

In the foregoing embodiments, the descriptions of the embodiments have respective focuses. A part that is not described in detail in an embodiment may refer to the above description of the information processing method.

In a specific implementation of this disclosure, relevant data such as the text and rich media involved, when the foregoing embodiments of this disclosure are applied to a specific product or technology, need to obtain the relevant user's permission or consent. In addition, the acquisition, use, and processing of relevant data need to comply with relevant laws, regulations, and standards of relevant countries and regions.

To better implement the information processing method provided in the embodiments of this disclosure, the embodiments of this disclosure further provide an apparatus based on the foregoing information processing method. The meaning of the noun is the same as that in the foregoing information processing method, and implementation details may refer to the descriptions in the method embodiment.

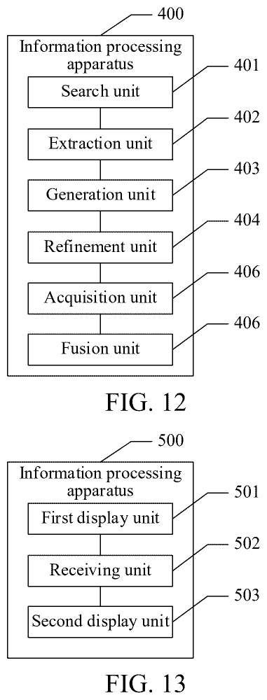

FIG. 12 is a schematic structural diagram of an information processing apparatus according to an embodiment of this disclosure. The information processing apparatus 400 may include a search unit 401, a first extraction unit 402, a generation unit 403, a second extraction unit 404 (also referred to as refinement unit 404), an acquisition unit 405, a fusion unit 406, and the like.

The search unit 401 is configured to receive to-be-queried information transmitted by a terminal, and perform a multimodal information search based on the to-be-queried information to obtain multimodal search results, the to-be-queried information being inputted from an interactive interface of the terminal. The first extraction unit 402 is configured to perform content digest extraction on a target text in the multimodal search results to obtain content digest fragments, relevance between the target text and the to-be-queried information being greater than a preset relevance threshold. The generation unit 403 is configured to generate, based on the content digest fragments, a text query result corresponding to the to-be-queried information. The second extraction unit 404 is configured to perform, if a first preset number of search results in the multimodal search results do not contain a first rich media query result, key information extraction on the text query result to obtain key description information corresponding to the text query result. The acquisition unit 405 is configured to acquire a second rich media query result corresponding to the key description information. The fusion unit 406 is configured to fuse the text query result and the second rich media query result to obtain a target query result, and transmit the target query result to the terminal.

In an implementation, the information processing apparatus 400 further includes: a result fusion unit configured to fuse, if the first preset number of search results in the multimodal search results contain first rich media query results, the text query result and the first rich media query results to obtain a target query result; and a first transmitting unit configured to transmit the target query result to the terminal.

In an implementation, the result fusion unit is further configured to: determine, if the first preset number of search results in the multimodal search results contain the first rich media query results, whether rich media types of the first rich media query results contained in the first preset number of search results are the same; fuse, if the rich media types are the same, the first rich media query result ranking first in the first preset number of search results with the text query result to obtain the target query result; and fuse, if the rich media types are different, the first rich media query results of various types ranking first among the first preset number of search results with the text query result to obtain the target query result.

In an implementation, the second extraction unit 404 is further configured to: use the text query result as an input of a generation model, and perform, based on integrity of text content, containing specified key information and a word count requirement, key information extraction through the generation model to obtain the key description information corresponding to the text query result.

In an implementation, the acquisition unit 405 may include: a search module configured to perform, if the key description information is inconsistent with the to-be-queried information, an information search based on the key description information to obtain a search result; and a determining module configured to determine the second rich media query result corresponding to the key description information according to rich media that is in the search result and has relevance to the key description information being greater than a target relevance threshold.

In an implementation, the determining module is further configured to: acquire a rich media cover link, a rich media jump link, and rich media click backhaul information of the rich media that is in the search result and has relevance to the key description information being greater than the target relevance threshold; and generate the second rich media query result corresponding to the key description information according to the rich media cover link, the rich media jump link, and the rich media click backhaul information.

In an implementation, the information processing apparatus 400 further includes: a second transmitting unit configured to transmit, if the key description information is consistent with the to-be-queried information, the text query result to the terminal.

In an implementation, there are a plurality of content digest fragments, and the generation unit 403 may include: a generation module configured to use the plurality of content digest fragments as inputs of the generation model, concatenate, through the generation model, the plurality of content digest fragments according to a preset text generation template, and add text reference jump links corresponding to the content digest fragments to output the text query result corresponding to the to-be-queried information.

In an implementation, the generation module is further configured to: concatenate, through the generation model, the plurality of content digest fragments according to the preset text generation template to output a concatenated text; perform semantic matching between the concatenated text and an original text corresponding to the content digest fragments; and add, if the concatenated text and the original text corresponding to the content digest fragments satisfy a matching condition, the text reference jump links corresponding to the content digest fragments to the concatenated text to obtain the text query result.

According to this embodiment of this disclosure, the search unit 401 may perform the multimodal information search on the to-be-queried information to obtain the multimodal search results. The first extraction unit 402 performs content digest extraction according to the target text in the multimodal search results to obtain the content digest fragments, and the relevance between the target text and the to-be-queried information is greater than the preset relevance threshold. The generation unit 403 generates, based on the content digest fragments, the text query result corresponding to the to-be-queried information. In addition, when the first preset number of search results in the multimodal search results do not contain the first rich media query result, the second extraction unit 404 may perform key information extraction on the text query result to obtain the key description information, and the acquisition unit 405 acquires the second rich media query result based on the key description information. The fusion unit 406 fuses the text query result and the second rich media query result to accurately obtain diversified target query results, thereby improving the accuracy and diversity of information processing.

To better implement the information processing method provided in the embodiments of this disclosure, the embodiments of this disclosure further provide an apparatus based on the foregoing information processing method. The meaning of the noun is the same as that in the foregoing information processing method, and implementation details may refer to the descriptions in the method embodiment.

FIG. 13 is a schematic structural diagram of an information processing apparatus according to an embodiment of this disclosure. The information processing apparatus 500 may include a first display unit 501, a receiving unit 502, a second display unit 503, and the like.

The first display unit 501 is configured to display an interactive interface, and receive inputted to-be-queried information in the interactive interface. The receiving unit 502 is configured to transmit the to-be-queried information to a server, and receive a target query result returned by the server based on the to-be-queried information, the target query result including a text query result and a rich media query result; the text query result being generated based on content digest fragments obtained by performing content digest extraction on a target text; the target text being a text that is in multimodal search results obtained by performing a multimodal information search for the to-be-queried information and has relevance to the to-be-queried information being greater than a preset relevance threshold; the rich media query result being a first rich media query result obtained based on a first preset number of search results in the multimodal search results, or a second rich media query result acquired based on key description information obtained by performing key information extraction on the text query result. The second display unit 503 is configured to display, in the interactive interface, the text query result and the rich media query result.

In an implementation, the text query result includes texts and text reference jump links, and the rich media query result includes rich media, a rich media cover link, a rich media jump link, and rich media click backhaul information. The second display unit 503 is further configured to: display, in a first display area of the interactive interface, the texts and the text reference jump links; and display, in a second display area of the interactive interface, a rich media identifier generated by the rich media, the rich media cover link, the rich media jump link, and the rich media click backhaul information.

In an implementation, the information processing apparatus 500 may further include: a third display unit configured to display, in response to a trigger operation for the text reference jump link, an original text corresponding to the text reference jump link.

In an implementation, the third display unit is further configured to display, in the interactive interface, a dialog box in a pop-up manner, and display, in the dialog box, the original text corresponding to the text reference jump link; or switch the interactive interface to a text display interface, and display, in the text display interface, the original text corresponding to the text reference jump link.

In an implementation, the information processing apparatus 500 may further include: a fourth display unit configured to generate, in response to a trigger operation for the rich media jump link, a media display interface, and display, in the media display interface, rich media corresponding to the rich media jump link.

In an implementation, the information processing apparatus 500 may further include: a fifth display unit configured to acquire, in response to a trigger operation for the rich media click backhaul information, a rich media type of the rich media; and acquire candidate rich media matching the rich media type, and display, in the media display interface, the candidate rich media.

In an implementation, the fifth display unit is further configured to: receive a page turning instruction, and switch, based on the page turning instruction, the candidate rich media currently displayed in the media display interface to another candidate rich media for displaying.

According to this embodiment of this disclosure, the first display unit 501 may receive the inputted to-be-queried information in the interactive interface. The receiving unit 502 transmits the to-be-queried information to the server and receives the target query result that includes the text query result and the rich media query result and is returned by the server based on the to-be-queried information so that the server performs, based on the text that is in the multimodal search results obtained by performing a multimodal information search on the to-be-queried information and has relevance to the to-be-queried information being greater than the preset relevance threshold, content digest extraction to obtain the content digest fragments, thereby generating the text query result. In addition, the rich media query result is obtained based on the key description information obtained by performing key information extraction on the text query result. In this case, the second display unit 503 may display, in the interactive interface, the text query result and the rich media query result, thereby improving the diversity and accuracy of the query result display.

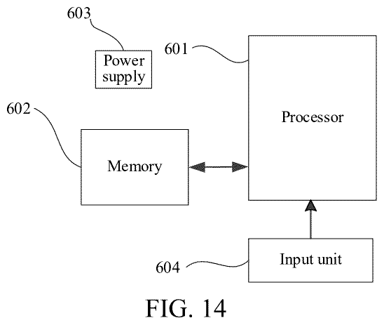

The embodiments of this disclosure further provide a computer device. The computer device may be a terminal, a server, or the like. As shown in FIG. 14, it shows a schematic structural diagram of a computer device according an embodiment of this disclosure. The computer device may include components such as a processor 601 with one or more processing cores, a memory 602 with one or more computer-readable storage media, a power supply 603, and an input unit 604. It is noted that a structure of the computer device shown in FIG. 14 does not constitute a limitation on the computer device, and the computer device may include more or fewer components than those shown in the figure, or some combined components, or different component arrangements.

The processor 601 is a control center of the computer device, is connected to all parts of the entire computer device using various interfaces and lines, and executes various functions of the computer device and performs data processing by running or executing a software program and/or a module stored in the memory 602 and invoking data stored in the memory 602. In some embodiments, the processor 601 may include one or more processing cores. In some examples, the processor 601 may integrate an application processor and a modem processor. The application processor mainly processes an operating system, a user interface, an application program, and the like. The modem processor mainly processes wireless communication. The foregoing modem processor may not be integrated into the processor 601.

The memory 602 may be configured to store the software program and the module, and the processor 601 executes various function applications and performs data processing by running the software program and the module stored in the memory 602. The memory 602 may mainly include a program storage region and a data storage region. The program storage region may store an operating system, an application program required by at least one function (such as a sound playing function and an image playing function), etc. The data storage region may store data created according to the use of the computer device, and the like. In addition, the memory 602 may include a high-speed random access memory (RAM) and a non-volatile memory, such as at least one magnetic disk storage device, a flash memory device, or other volatile solid-state storage devices. Correspondingly, the memory 602 may further include a memory controller to provide access of the processor 601 to the memory 602.

The computer device further includes the power supply 603 for supplying power to various components. In some examples, the power supply 603 may be logically connected to the processor 601 through a power management system, thereby implementing functions such as charging, discharging, and power consumption management through the power management system. The power supply 603 may further include one or more of a direct current or alternating current power supply, a re-charging system, a power failure detection circuit, a power supply converter or inverter, a power supply state indicator, and any other assemblies.

The computer device may further include the input unit 604. The input unit 604 may be configured to receive inputted number or character information and generate a keyboard, mouse, joystick, optical or trackball signal input related to user settings and function control.

Although not shown, the computer device may further include a display unit and the like. In this embodiment, the processor 601 in the computer device loads executable files corresponding to processes of one or more application programs to the memory 602 based on the following instructions and runs the application programs stored in the memory 602 to achieve various functions as follows.

When the computer device is a server, the computer device may receive to-be-queried information that is transmitted by a terminal and inputted in an interactive interface, and perform a multimodal information search based on the to-be-queried information to obtain multimodal search results. performing content digest extraction according to a target text in the multimodal search results to obtain content digest fragments, relevance between the target text and the to-be-queried information being greater than a preset relevance threshold; generating, based on the content digest fragments, a text query result corresponding to the to-be-queried information; performing, if a first preset number of search results in the multimodal search results do not contain a first rich media query result, key information extraction on the text query result to obtain key description information corresponding to the text query result; acquiring a second rich media query result corresponding to the key description information; and fusing the text query result and the second rich media query result to obtain a target query result, and transmitting the target query result to the terminal.

When the computer device is a terminal, an interactive interface may be displayed, and inputted to-be-queried information is received in the interactive interface. transmitting the to-be-queried information to a server, and receiving a target query result returned by the server based on the to-be-queried information, the target query result including a text query result and a rich media query result; the text query result being generated based on content digest fragments obtained by performing content digest extraction on a text that is in multimodal search results obtained by performing a multimodal information search for the to-be-queried information and has relevance to the to-be-queried information being greater than a preset relevance threshold; the rich media query result being a first rich media query result obtained based on a first preset number of search results in the multimodal search results, or a second rich media query result acquired based on key description information obtained by performing key information extraction on the text query result; and displaying, in the interactive interface, the text query result and the rich media query result.

In the foregoing embodiments, the descriptions of the embodiments have respective focuses. A part that is not described in detail in an embodiment may refer to the above description of the information processing method.

According to an aspect of this disclosure, a computer program product or a computer program is provided. The computer program product or the computer program includes a computer instruction, and the computer instruction is stored in a computer-readable storage medium. A processor of a computer device reads the computer instruction from the computer-readable storage medium and executes the computer instruction to cause the computer device to perform the methods provided in the implementations in the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that all or some operations of the methods in the foregoing embodiments may be completed through the computer instruction, or completed through relevant hardware controlled by the computer instruction. The computer instruction may be stored in a computer-readable storage memory (i.e., storage medium) and loaded and executed by a processor. Therefore, the embodiments of this disclosure provide a storage medium, having a computer program stored therein. The computer program may include a computer instruction and can be loaded by a processor to perform any information processing method provided in the embodiments of this disclosure. Specific implementations of the above operations may refer to the foregoing embodiments.

The storage medium may include: a read-only memory (ROM), a RAM, a magnetic disk, an optical disc, or the like.

Since the instruction stored in the storage medium may perform the operations of any information processing method provided in the embodiments of this disclosure, the beneficial effects that can be achieved by information processing method provided in the embodiments of this disclosure may be achieved. The foregoing embodiments may be referred to for details.

The information processing method and apparatus, the computer device, and the storage medium provided in the embodiments of this disclosure are described above in detail. The principle and the implementations of this disclosure are illustrated using specific examples. The description of the above embodiments is configured for facilitating understanding of the methods of this disclosure. Meanwhile, it is noted that there will be changes in the specific embodiments and the disclosure scope of this disclosure. In summary, the content of this specification cannot be construed as a limitation to this disclosure.

What is claimed is:

1. An information processing method, comprising:
receiving, by a server device, to-be-queried information that is transmitted from a terminal device,
performing, by the server device, a multimodal information search based on the to-be-queried information to obtain multimodal search results;
performing a content digest extraction of a target text in the multimodal search results to obtain one or more content digest fragments, relevance between the target text and the to-be-queried information being greater than a preset relevance threshold;
generating, based on the one or more content digest fragments, a text query result corresponding to the to-be-queried information;
performing, when a first preset number of search results in the multimodal search results lack a rich media query result, key information extraction on the text query result to obtain key description information corresponding to the text query result;
acquiring a supplemental rich media query result according to the key description information, the supplemental rich media query result comprising one or more rich media items;
fusing the text query result and the supplemental rich media query result to obtain a target query result; and
transmitting the target query result to the terminal device.

2. The information processing method according to claim 1, wherein the fusing comprises:
fusing, when the first preset number of search results in the multimodal search results comprises at least a first rich media query result, the text query result and at least the first rich media query result to obtain the target query result.

3. The information processing method according to claim 2, wherein the fusing comprises:
fusing, when the first preset number of search results in the multimodal search results includes a plurality of rich media query results and rich media types of the plurality of rich media query results are of a same type, the first rich media query result with the text query result to obtain the target query result, the first rich media query result being ranked first among the plurality of rich media query results; and
fusing, when the plurality of rich media query results are of different rich media types, first ranking rich media query results respectively of the different rich media types with the text query result to obtain the target query result, the first ranking rich media query results respectively being ranked first of the different rich media types.

4. The information processing method according to claim 1, wherein the performing the key information extraction comprises:
inputting the text query result into a generation model; and
performing, according to at least one of an integrity requirement of text content, a containing requirement of specified key information and a word count requirement, the key information extraction using the generation model to obtain the key description information corresponding to the text query result.

5. The information processing method according to claim 1, wherein the acquiring the supplemental rich media query result comprises:
performing, when the key description information is inconsistent with the to-be-queried information, an information search based on the key description information to obtain a search result;
determining that the search result includes at least a rich media item with a relevance to the key description information being greater than a target relevance threshold; and
determining the supplemental rich media query result according to the rich media item.

6. The information processing method according to claim 5, wherein the determining the supplemental rich media query result comprises:
acquiring a rich media cover link, a rich media jump link, and rich media click backhaul information of the rich media item; and
generating the supplemental rich media query result corresponding to the key description information according to the rich media cover link, the rich media jump link, and the rich media click backhaul information.

7. The information processing method according to claim 5, further comprising:
transmitting, when the key description information is consistent with the to-be-queried information, the text query result to the terminal device.

8. The information processing method according to claim 1, wherein the one or more content digest fragments comprises a plurality of content digest fragments, and the generating the text query result comprises:
inputting the plurality of content digest fragments in a generation model;
concatenating, by using the generation model, the plurality of content digest fragments according to a preset text generation template to obtain a concatenated text; and
adding text reference jump links respectively of the plurality of content digest fragments in the concatenated text to obtain the text query result corresponding to the to-be-queried information.

9. The information processing method according to claim 8, wherein the adding comprises:
performing semantic matching between the concatenated text and the plurality of content digest fragments; and
adding, when the semantic matching satisfies a matching condition, the text reference jump links of the plurality of content digest fragments to the concatenated text to obtain the text query result.

10. An information processing method, comprising:
receiving, via an interactive interface of a terminal device, to-be-queried information;
transmitting the to-be-queried information to a server device;
receiving a target query result that is generated by the server device based on the to-be-queried information, the target query result comprising a text query result and a rich media query result that are fused together, the text query result being generated based on one or more content digest fragments that are extracted by performing a content digest extraction of a target text in multimodal search results of the to-be-queried information, a relevance between the target text and the to-be-queried information being greater than a preset relevance threshold, the rich media query result including one of a first rich media query result obtained based on a first preset number of search results in the multimodal search results, or a supplemental rich media query result acquired based on key description information that is obtained by performing key information extraction on the text query result; and
displaying, in the interactive interface, the target query result that includes the text query result and the rich media query result.

11. The information processing method according to claim 10, wherein the text query result comprises texts and one or more text reference jump links, and the rich media query result comprises a rich media item, a rich media cover link, a rich media jump link, and rich media click backhaul information; and the displaying the target query result comprises:
displaying, in a first display area of the interactive interface, the texts and the one or more text reference jump links; and
displaying, in a second display area of the interactive interface, a rich media identifier that is generated based on the rich media item, the rich media cover link, the rich media jump link, and the rich media click backhaul information.

12. The information processing method according to claim 11, further comprising:
displaying, in response to a trigger operation on a text reference jump link in the one or more text reference jump links, an original text corresponding to the text reference jump link.

13. The information processing method according to claim 12, wherein the displaying the original text comprises:
displaying, in the interactive interface, a dialog box in a pop-up manner; and
displaying, in the dialog box, the original text corresponding to the text reference jump link.

14. The information processing method according to claim 12, wherein the displaying the original text comprises:
switching the interactive interface to a text display interface; and
displaying, in the text display interface, the original text corresponding to the text reference jump link.

15. The information processing method according to claim 11, further comprising:
generating, in response to a trigger operation on the rich media jump link, a media display interface; and
displaying, in the media display interface, an original rich media item corresponding to the rich media jump link.

16. The information processing method according to claim 11, further comprising:
acquiring, in response to a trigger operation on the rich media click backhaul information, a rich media type of the rich media item;
acquiring one or more candidate rich media items having the rich media type; and
displaying, in a media display interface, the one or more candidate rich media items.

17. The information processing method according to claim 16, wherein the one or more candidate rich media items comprises a plurality of candidate rich media items, and the displaying the one or more candidate rich media items comprises:
displaying a first candidate rich media item in the plurality of candidate rich media items in the media display interface;
receiving a page turning instruction; and
switching, based on the page turning instruction, from the first candidate rich media item to a second candidate rich media item in the plurality of candidate rich media items for displaying in the media display interface.

18. An information processing server device, comprising processing circuitry configured to:
receive to-be-queried information that is transmitted from a terminal device,
perform a multimodal information search based on the to-be-queried information to obtain multimodal search results;
perform a content digest extraction of a target text in the multimodal search results to obtain one or more content digest fragments, relevance between the target text and the to-be-queried information being greater than a preset relevance threshold;
generate, based on the one or more content digest fragments, a text query result corresponding to the to-be-queried information;
perform, when a first preset number of search results in the multimodal search results lack a rich media query result, key information extraction on the text query result to obtain key description information corresponding to the text query result;
acquire a supplemental rich media query result according to the key description information, the supplemental rich media query result comprising one or more rich media items;
fuse the text query result and the supplemental rich media query result to obtain a target query result; and
transmit the target query result to the terminal device.

19. The information processing server device according to claim 18, wherein the processing circuitry is configured to:
fuse, when the first preset number of search results in the multimodal search results comprises at least a first rich media query result, the text query result and at least the first rich media query result to obtain the target query result.

20. The information processing server device according to claim 19, wherein the processing circuitry is configured to:
fuse, when the first preset number of search results in the multimodal search results includes a plurality of rich media query results and rich media types of the plurality of rich media query results are of a same type, the first rich media query result with the text query result to obtain the target query result, the first rich media query result being ranked first among the plurality of rich media query results; and
fuse, when the plurality of rich media query results are of different rich media types, first ranking rich media query results respectively of the different rich media types with the text query result to obtain the target query result, the first ranking rich media query results respectively being ranked first of the different rich media types.
